(19) United States
(12) Patent Application Publication
(10) Pub. No.: US 2013/0099623 A1
(43) Pub. Date: Apr. 25, 2013

(54) DISK ROTATING MOTOR AND DISK DRIVE DEVICE PROVIDED WITH THE SAME

(71) Applicants: MINEBEA CO., LTD., Kitasaku-gun (JP); MINEBEA MOTOR MANUFACTURING CORPORATION, Tokyo (JP)

(72) Inventors: Makoto TABATA, Yonago-shi (JP); Kyo ABE, Yonago-shi (JP); Toshiyuki NISHIKATA, Yonago-shi (JP)

(73) Assignees: MINEBEA MOTOR MANUFACTURING CORPORATION, Tokyo (JP); MINEBEA CO., LTD., Kitasaku-gun (JP)

(21) Appl. No.: 13/657,236

(22) Filed: Oct. 22, 2012

(30) Foreign Application Priority Data
Oct. 25, 2011 (JP) 2011-233790
Oct. 28, 2011 (JP) 2011-236627

(51) Int. Cl. H02K 1/18

(52) U.S. Cl. 310/216.113

(57) ABSTRACT

A disk rotating motor is provided with: a bearing that rotatably supports a shaft on an outer-diameter side of the shaft; and a stator core that is fixed to an outer peripheral surface of the bearing. The stator core includes first and second plates laminated in an extension direction of the shaft. The first plate includes: a laminate laminated on the second plate in the extension direction of the shaft; and a bend bent from the laminate toward the second plate on an inner-diameter side of the laminate, the bend being in contact with the outer peripheral surface of the bearing.

This application is based on Japanese Patent Applications No. 2011-233790 filed with the Japan Patent Office on Oct. 25, 2011 and No. 2011-236627 filed with the Japan Patent Office on Oct. 28, 2011, the entire contents of which are hereby incorporated by reference.

### BACKGROUND OF THE INVENTION

1. Field of the Invention

The present invention relates to a disk rotating motor and a disk drive device provided with the same and, more particularly, to a disk rotating motor that can be fabricated in a simple method and a disk drive device provided with the same.

2. Description of the Related Art

When information is written in or read from a recording medium having information recorded therein such as an optical disk or a magneto-optical disk, a disk drive device is used to rotate a disk. The disk drive device includes a disk rotating motor for rotating the disk. The techniques relevant to the disk rotating motor in the prior art are disclosed in, for example, Documents 1 to 3 described below.

Document 1 discloses a small-sized disk motor, in which a stator core is molded with a resin simultaneously with insulation treatment, and further, a sintered metal bearing is press-fitted to the stator core on the inner-diameter side thereof via a resin layer.

Document 2 discloses a motor for a dynamic pressure bearing, in which a support frame and the dynamic pressure bearing are integrally molded with sintered metallic powder, and further, a dynamic pressure generating groove is formed at the inner circumferential surface of a stationary bearing portion.

The motors disclosed in Documents 1 and 2 include the stator core having a plurality of plates in lamination and the bearing made of a porous material containing metal oil (i.e., a lubricant), wherein the laminated core is press-fitted directly to the bearing (i.e., the metal).

However, when the laminated core is press-fitted directly to the bearing, the metal oil staying in the bearing is sucked into clearances defined between the plates constituting the laminated core in a capillary phenomenon, thereby remarkably seriously degrading a function. In view of this, a bearing housing unit or the like is generally interposed between the laminated core and the bearing, thus fixing (i.e., tightening) the laminated core.

Document 3 discloses a fan including a shaft, an impeller insert-molded in the shaft, a sleeve constituting a slide bearing in cooperation with the shaft, a bearing retainer having the sleeve securely press-fitted thereinto, and a stator fixed to the outer peripheral side surface of the bearing retainer. The stator includes a stator core, an insulator, and a coil wound around the stator core via the insulator. A projection projecting toward the impeller beyond the bearing retainer is formed at the inner-diameter end of the insulator. The large-diameter portion of the impeller hooks on the projection in the insulator in an axial direction, thus stopping the shaft from falling from the sleeve.

Document 1: Japanese Patent Publication Laying-Open No. 9-252568

Document 2: Japanese Patent Publication Laying-Open No. 8-308172

Document 3: Japanese Patent Publication Laying-Open No. 2007-236189

Cost reduction has been strongly required for the disk rotating motor in recent years. In order to reduce the cost of the disk rotating motor, the disk rotating motor needs be fabricated in a simple method. For example, the number of component parts for the disk rotating motor is reduced; or not a relatively complicated (i.e., expensive) processing method such as cutting but a relatively simple (i.e., inexpensive) method such as pressing needs be used to process component parts constituting the disk rotating motor. Moreover, not a complicated tightening method but a relatively ready (i.e., inexpensive) tightening method typified by press-fitting needs to be adopted with high assembling precision in assembling the component parts.

The prior art has been susceptible to improvement from the viewpoint of simplification of the fabricating method. As especially disclosed in Documents 1 and 2, although the number of component parts should be desirably reduced to achieve cost reduction, the bearing housing has been needed for the above-described reason. The insulator disclosed in Document 3 is configured such as to project toward the impeller beyond the bearing retainer, and therefore, has the complicated shape.

### SUMMARY OF THE INVENTION

An object of the present invention is to provide a disk rotating motor that can be fabricated in a simple method, and a disk drive device provided with the same.

A disk rotating motor according to one aspect of the present invention is provided with: a bearing that rotatably supports a rotary shaft on the outer-diameter side of the rotary shaft; and a stator core that is fixed to the outer peripheral surface of the bearing, the stator core including first and second plates laminated in the extension direction of the rotary shaft, the first plate including: a laminate laminated on the second plate in the extension direction of the rotary shaft; and a bend bent from the laminate toward the second plate on the inner-diameter side of the laminate, the bend being in contact with the outer peripheral surface of the bearing.

A disk rotating motor according to another aspect of the present invention is provided with: a rotary shaft; a bearing that rotatably supports the rotary shaft on the outer-diameter side of the rotary shaft; and a stator that fixes the bearing, the stator including: a stator core that is fixed to the outer peripheral surface of the bearing; a coil that is wound around the stator core; and an insulator that insulates the stator core and the coil from each other, the rotary shaft including a groove formed at the outer peripheral surface of the rotary shaft, the insulator including a fitted portion that is fitted to the groove, wherein the fitted portion is formed at an end on the inner-diameter side of the insulator.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating the configuration of a disk drive device in a first embodiment according to the present invention.

FIG. 2 is a bottom view schematically showing the configuration of a disk rotating motor in the first embodiment according to the present invention.

FIG. 3 is a cross-sectional perspective view taken along line IV-IV in FIG. 2.

FIG. 4 is a cross-sectional view taken along the line IV-IV in FIG. 2.

FIG. 5 is a perspective view showing the configuration of a plate 51 in the first embodiment according to the present invention, as viewed on a side facing a rotor 10.

FIG. 6 is a perspective view showing the configuration of plate 51 in the first embodiment according to the present invention, as viewed on a side facing a bracket 23.

FIG. 7 is a perspective view showing the configuration of a plate 52 or 53 in the first embodiment according to the present invention, as viewed on the side facing rotor 10.

FIG. 8 is a perspective view showing the configuration of bracket 23 in the first embodiment according to the present invention, as viewed on the side facing rotor 10.

FIG. 9 is a perspective view showing a stator core 21 obtained in a first process in a fabricating method for the disk rotating motor in the first embodiment according to the present invention, as viewed on the side facing rotor 10.

FIG. 10 is a perspective view showing stator core 21 obtained in the first process in the fabricating method for the disk rotating motor in the first embodiment according to the present invention, as viewed on the side facing bracket 23.

FIG. 11 is a perspective view showing a wire-wound assembly obtained in a second process in the fabricating method for the disk rotating motor in the first embodiment according to the present invention, as viewed on the side facing rotor 10.

FIG. 12 is a perspective view showing the wire-wound assembly obtained in the second process in the fabricating method for the disk rotating motor in the first embodiment according to the present invention, as viewed on the side facing bracket 23.

FIGS. 13 to 15 are perspective views showing fifth to seventh processes in the fabricating method for the disk rotating motor in the first embodiment according to the present invention.

FIG. 16 is a cross-sectional view schematically showing the partial configuration of plate 51 in the disk rotating motor in a first modification of the first embodiment according to the present invention.

FIG. 17 is a cross-sectional view schematically showing the partial configuration of plate 51 in the disk rotating motor in a second modification of the first embodiment according to the present invention.

FIG. 18 is a cross-sectional view schematically showing the configuration of the disk rotating motor in a third modification of the first embodiment according to the present invention.

FIG. 19 is a cross-sectional perspective view showing the configuration of a disk drive device in a second embodiment according to the present invention, taken along the line IV-IV in FIG. 2.

FIG. 20 is a cross-sectional perspective view showing the configuration of the disk drive device in the second embodiment according to the present invention, taken along the line IV-IV in FIG. 2.

FIG. 21 is a perspective view showing the configuration of an insulator 26 in the second embodiment according to the present invention, as viewed on the side facing a rotor 10.

FIG. 22 is a perspective view showing the configuration of insulator 26 in the second embodiment according to the present invention, as viewed on the side facing a bracket 23.

FIG. 23 is a perspective view showing the configuration of a plate 52 or 53 in the second embodiment according to the present invention, as viewed on the side facing rotor 10,

FIG. 24 is a perspective view showing a stator core 21 obtained in a first process in a fabricating method for the disk rotating motor in the second embodiment according to the present invention, as viewed on the side facing rotor 10.

FIG. 25 is a perspective view showing stator core 21 obtained in the first process in the fabricating method for the disk rotating motor in the second embodiment according to the present invention, as viewed on the side facing bracket 23.

FIG. 26 is a perspective view showing a wire-wound assembly obtained in a second process in the fabricating method for the disk rotating motor in the second embodiment according to the present invention, as viewed on the side facing bracket 23.

FIG. 27 is a cross-sectional view schematically showing a configuration near a stopper washer 26a in the disk rotating motor in a first modification of the second embodiment according to the present invention.

FIG. 28 is a cross-sectional view schematically showing the disk rotating motor in a second modification of the second embodiment according to the present invention.

### DESCRIPTION OF THE PREFERRED EMBODIMENTS

Hereinafter, embodiments according to the present invention will be described with reference to the attached drawings.

In the following description, “an outer diameter side” signifies an outer diameter side when the rotary shaft of a disk rotating motor is referred to as the center whereas “an inner diameter side” signifies an inner diameter side when the rotary shaft of the disk rotating motor is referred to as the center. Moreover, “an outer peripheral surface” signifies an outer peripheral surface when the rotary shaft of the disk rotating motor is referred to as the center whereas “an inner circumferential surface” signifies an inner circumferential surface when the rotary shaft of the disk rotating motor is referred to as the center.

[First Embodiment]

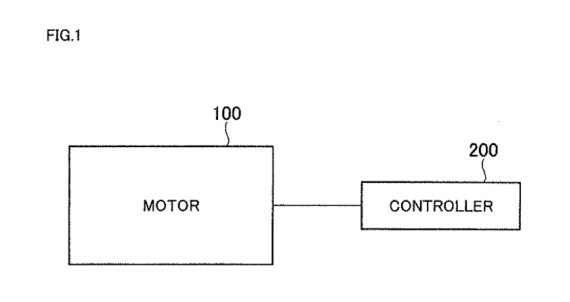

FIG. 1 is a block diagram illustrating the configuration of a disk drive device in a first embodiment according to the present invention.

Referring to FIG. 1, a disk drive device in the present embodiment is provided with a motor 100 serving as a disk rotating motor and a controller 200 for controlling the drive state of motor 100 such as ON/OFF or a rotational speed.

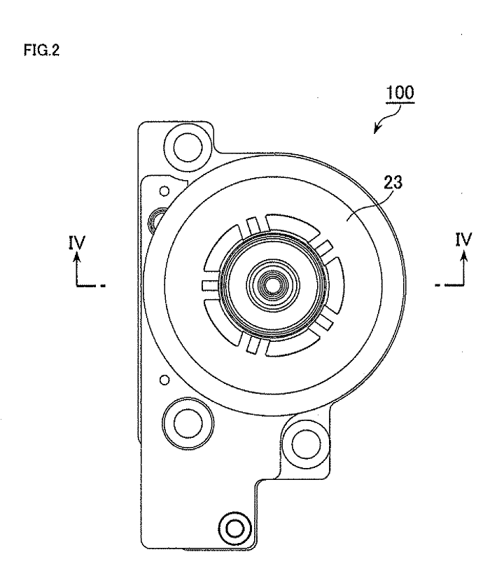

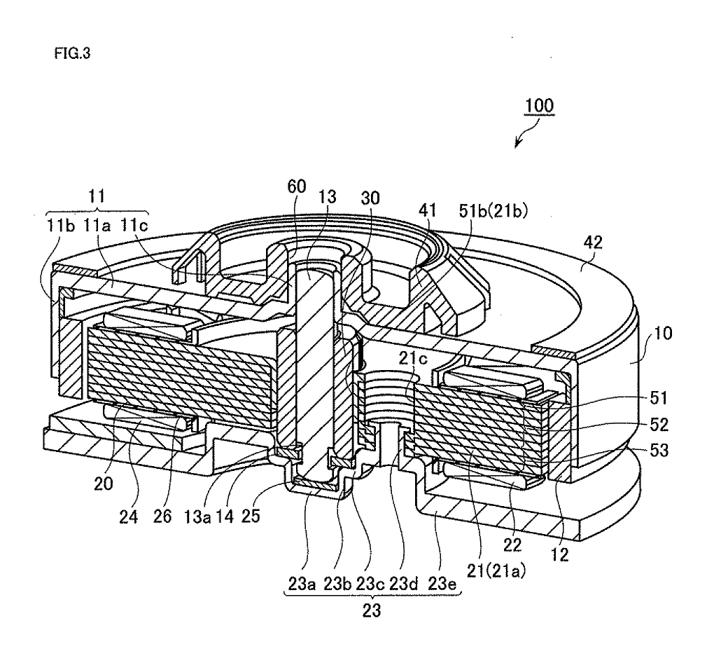

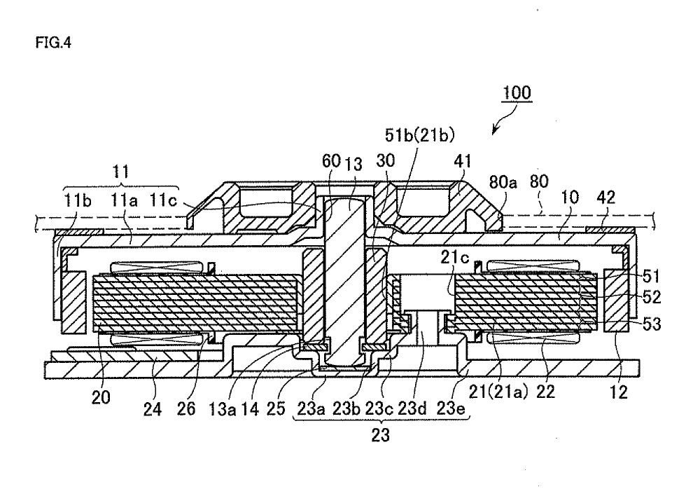

FIGS. 2 to 4 are schematic views showing the configuration of a disk rotating motor in the first embodiment according to the present invention, wherein FIG. 2 is a bottom view, FIG. 3 is a cross-sectional perspective view taken along line IV-IV in FIG. 2, and FIG. 4 is a cross-sectional view taken along the line IV-IV in FIG. 2.

Referring to FIGS. 2 to 4, motor 100 includes mainly a rotor 10, a stator 20, and a bearing 30. Rotor 10 is rotatable with respect to stator 20. Bearing 30 rotatably supports rotor 10 with respect to stator 20.

Rotor 10 includes a rotor frame 11, a magnet 12, a shaft 13 serving as a rotary shaft, and a stopper washer 14. Rotor frame 11 is adapted to prevent leakage of a magnetic field from the inside thereof, and therefore, is made of a magnetic material. Moreover, rotor frame 11 includes a turn table 11a and a side wall 11b. Turn table 11a extends in, for example, a direction (or a lateral direction in FIG. 4) perpendicular to the extension direction of shaft 13 (hereinafter often referred to as an axial direction). Moreover, turn table 11a is formed into a circular shape, as viewed on a plane. Additionally, turn table 11a has a hole 60, through which shaft 13 is inserted, at the center thereof. As a consequence, rotor frame 11 is fixed to shaft 13 inserted into hole 60. Side wall 11b extends toward a bracket 23 (downward in FIG. 4) in stator 20 from the outer-diameter end of turn table 11a. Moreover, side wall 11b is formed into a cylindrical shape.

Magnet 12 is fixed to the inner circumferential surface of side wall 11b. Magnet 12 is formed into an annular shape, and includes regions magnetized to an N pole and regions magnetized to an S pole alternately at constant intervals in a circumferential direction. Magnet 12 is fixed to rotor frame 11 in such a manner as to face stator 20.

Shaft 13 extends in a vertical direction in FIG. 4 in such a manner as to penetrate the center of rotor frame 11. Rotor frame 11 can be rotated on and with shaft 13. Shaft 13 is rotatably supported by bearing 30 disposed on the outer-diameter side thereof.

Stopper washer 14 is fitted into a groove 13a formed at the outer peripheral surface of shaft 13 near the lower end of shaft 13 in FIG. 4. When shaft 13 is moved upward in FIG. 4, stopper washer 14 is brought into contact with bearing 30, thereby preventing shaft 13 from falling off upward in FIG. 4. Stopper washer 14 is positionally restricted between bearing 30 and a third bottom 23c of bracket 23.

Stator 20 includes a stator core 21 (i.e., a core), a stator coil 22, bracket 23, a bottom plate 24, a thrust plate 25, and an insulator 26. Stator core 21 is fixed to the outer peripheral surface of bearing 30, and fixed to bracket 23 by, for example, flanging and caulking. Stator core 21 includes a plurality of teeth 21a radially extending from its inner diameter side toward its outer diameter side. Stator coil 22 is wound around each of teeth 21a. Bottom plate 24 is made of, for example, a magnetic material, and is fixed onto rotor 10 side in bracket 23. Thrust plate 25 is formed into, for example, a circular shape, and has a contact surface in contact with the lower end of shaft 13 in FIG. 4. Thrust plate 25 receives a thrust load of shaft 13. Insulator 26 is interposed between stator core 21 and stator coil 22, thereby insulating them from each other.

Stator core 21 has a hole 21b (i.e., a core center hole) formed at the center thereof and holes 21c (i.e., peripheral through holes) evenly spaced at a plurality of positions (e.g., three positions) around the circumference of hole 21b. Each of holes 21b and 21c penetrates stator core 21 in the axial direction. Bearing 30 is press-fitted into hole 21b, and therefore, is fixed to stator core 21.

Stator core 21 has a structure in which a plurality of plates are laminated in the axial direction. Stator core 21 is constituted of, for example, three plates 51 to 53 (i.e., a laminated core) having different shapes. Plates 51 to 53 are brought into contact with each other. Plates 51 to 53 are axially laminated in this order from the side of rotor frame 11 (an upper side in FIG. 4) toward the side of bracket 23 (a lower side in FIG. 4). The number of plates 51 to 53 may be optionally determined.

Bearing 30 is made of, for example, a porous material containing metal oil.

Motor 100 further includes a centering member 41 and a cushion rubber 42. Turn table 11a has an inner-diameter end 11c bent upward in FIG. 4. Centering member 41 is fixed at the outer peripheral surface of inner-diameter end 11c. A spring, not shown, is interposed between centering member 41 and inner-diameter end 11c, to thus urge centering member 41 in the outer-diameter direction. Cushion rubber 42 is disposed at the upper surface of turn table 11a in FIG. 4. When a disk 80 is mounted on the disk drive device, disk 80 is mounted on cushion rubber 42 in such a manner that an opening 80a formed at the center thereof is fitted to centering member 41. Centering member 41 presses the inner circumferential surface of opening 80a of disk 80 by the effect of the spring, thereby fixing disk 80. Cushion rubber 42 is adapted to suppress the vertical vibration of disk 80 in FIG. 4.

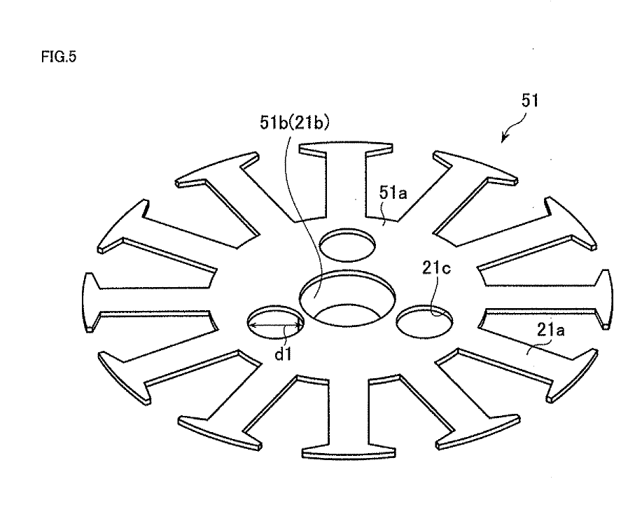

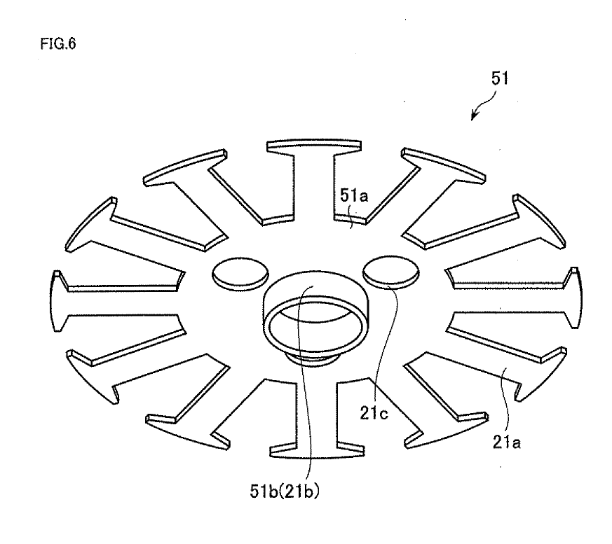

FIGS. 5 and 6 are perspective views showing the configuration of plate 51 in the first embodiment according to the present invention, wherein FIG. 5 is a view as viewed on a side facing rotor 10 whereas FIG. 6 is a view as viewed on a side facing bracket 23.

Referring to FIGS. 5 and 6, plate 51 (i.e., an inward bent core having a large through hole) includes a laminate 51a and a cylindrical bend 51b. Laminate 51a is flat and is axially laminated at the upper end of stator core 21 in FIG. 4. Laminate 51a has teeth 21a and holes 21c formed thereat. Bend 51b is bent from laminate 51a toward plate 52 on the inner-diameter side of laminate 51a. Bend 51b extends in the axial direction, thereby defining hole 21b. Bearing 30 is tightly press-fitted to bend 51b, and therefore, the inner circumferential surface of bend 51b is brought into contact with the outer peripheral surface of bearing 30. The outer peripheral surface of bend 51b is brought into contact with the inner-diameter ends of plates 52 and 53. Bend 51b extends between the inner-diameter ends of plates 52 and 53 and bearing 30. Hole 21c has a diameter d1.

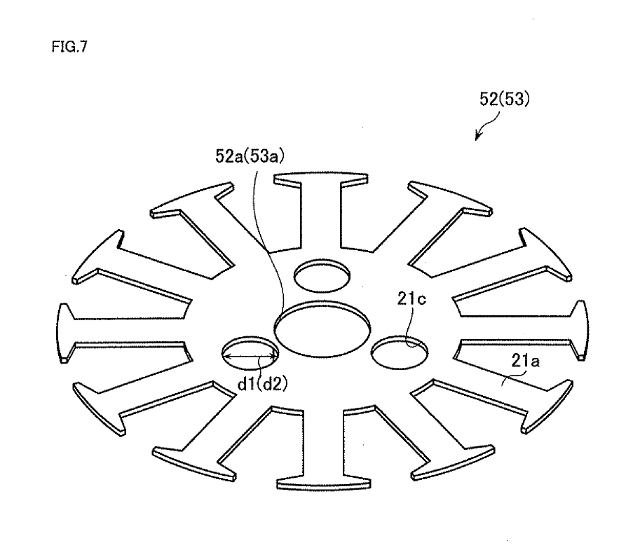

FIG. 7 is a perspective view showing the configuration of plate 52 or 53 in the first embodiment according to the present invention, as viewed on the side facing rotor 10.

Referring to FIG. 7, plate 52 (i.e., a core having a large through hole) and plate 53 (i.e., a core having a small through hole) are flat and are axially laminated together with plate 51. Plate 52 has a plurality of teeth 21 a, a hole 52a, and holes 21c. Similarly, plate 53 has a plurality of teeth 21a, a hole 53a, and holes 21c. Hole 21c formed in plate 52 has a diameter dl whereas hole 21c formed in plate 53 has a diameter d2 that is smaller than diameter d1. Diameter d1 is slightly greater than the diameter of a burring portion 23d of bracket 23. Diameter d2 is large enough to enable burring portion 23d of bracket 23 and hole 21c of plate 53 to be fitted to each other. Bend 51b of plate 51 extends between the inner circumferential surface of hole 52a or 53a (i.e., the inner-diameter end of plate 52 or 53) and bearing 30.

Although bend Sib of plate 51 need not cover the inner-diameter ends of all of plates 52 and 53, it should desirably have a length enough to exhibit the desired fixing strength of stator core 21 fixed to bearing 30.

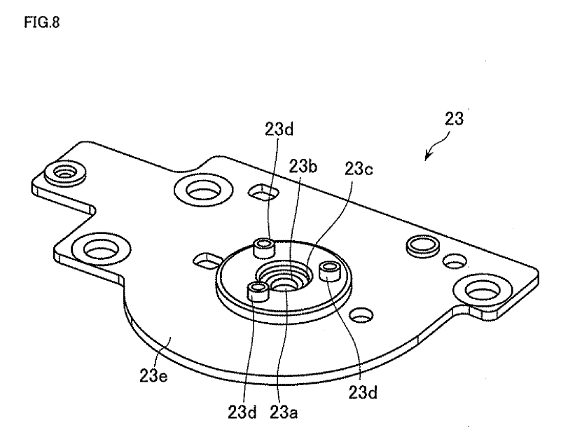

FIG. 8 is a perspective view showing the configuration of bracket 23 in the first embodiment according to the present invention, as viewed on the side facing rotor 10.

Referring to FIGS. 4 and 8, bracket 23 includes a first bottom 23a, a second bottom 23b, third bottom 23c, burring portion 23d, and an outer edge 23e. First to third bottoms 23a to 23c are formed at the center of bracket 23, thereby supporting the lower end of shaft 13 in FIG. 4. First bottom 23a in bracket 23 is located closest to the lower end of shaft 13 in FIG. 4 and extends in the lateral direction in FIG. 4. Second bottom 23b axially extends between the outer-diameter end of first bottom 23a and the inner-diameter end of third bottom 23c. Third bottom 23c extends from the upper end of second bottom 23b in the lateral direction in FIG. 4. Outer edge 23e extends from the outer-diameter end of third bottom 23c to the outer-diameter side beyond the outer-diameter end of stator core 21. Holes are evenly spaced at a plurality of portions (e.g., three portions) on the circumference of first bottom 23a at outer edge 23e, and then, burring portions 23d are formed around the holes, respectively. Burring portion 23d is formed at a position corresponding to hole 2k. Each of burring portions 23d extends from outer edge 23e toward stator core 21 (upward in FIG. 4).

First bottom 23a is brought into contact with thrust plate 25 on a side opposite to the contact surface of thrust plate 25 with shaft 13. Second bottom 23b surrounds the outer periphery of thrust plate 25. Bottom plate 24 is formed at outer edge 23e. Burring portion 23d is inserted into hole 21c formed in plate 53. The upper end of burring portion 23d is deformed in the outer-diameter direction of hole 21c formed in plate 53. Consequently, stator core 21 is tightened directly to bracket 23.

Incidentally, motor 100 may include an attractive magnet for magnetically attracting rotor 10 so as to stabilize the axial position of rotor 10. Attractive magnet may be fixed to the outer peripheral surface of bearing 30 in such a manner as to be brought into contact with plate 51 of stator core 21.

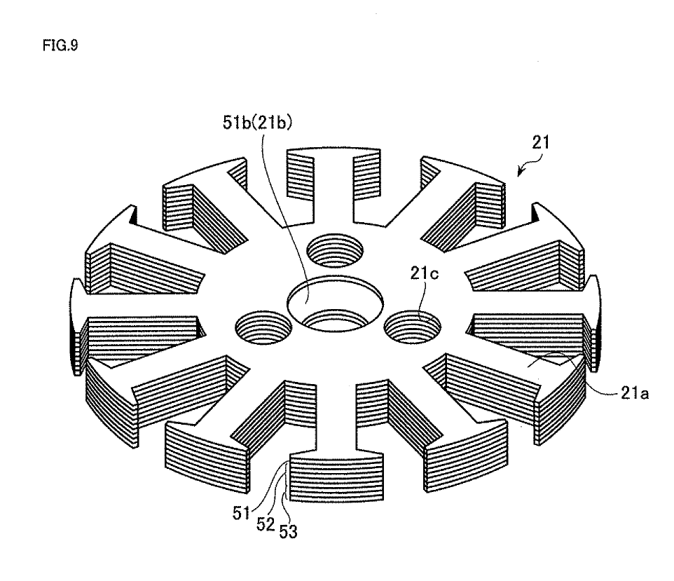

Next, a description will be given of one example of a fabricating method for the disk rotating motor in the present embodiment with reference to FIGS. 9 to 15.

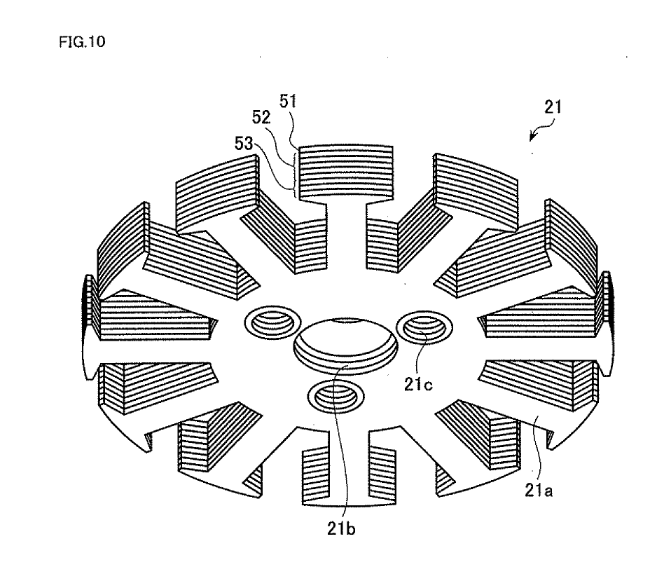

Referring to FIGS. 9 and 10, a piece of metallic flat plate, for example, is first subjected to plastic machining such as pressing, thus fabricating plates 51 to 53. Subsequently, plates 51 to 53 are laminated, thus fabricating stator core 21.

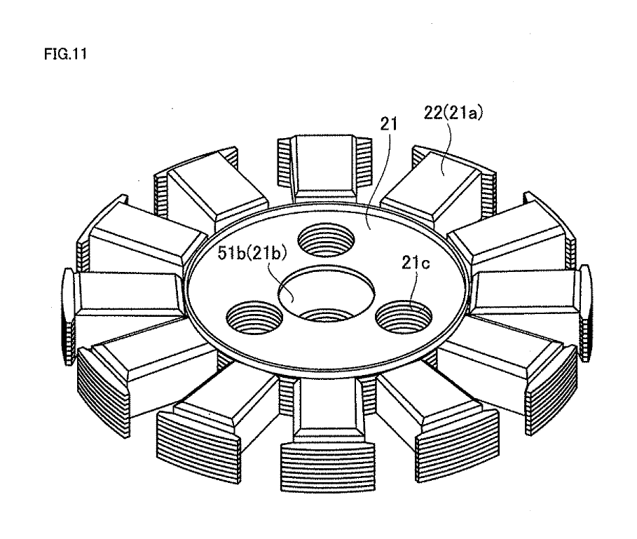

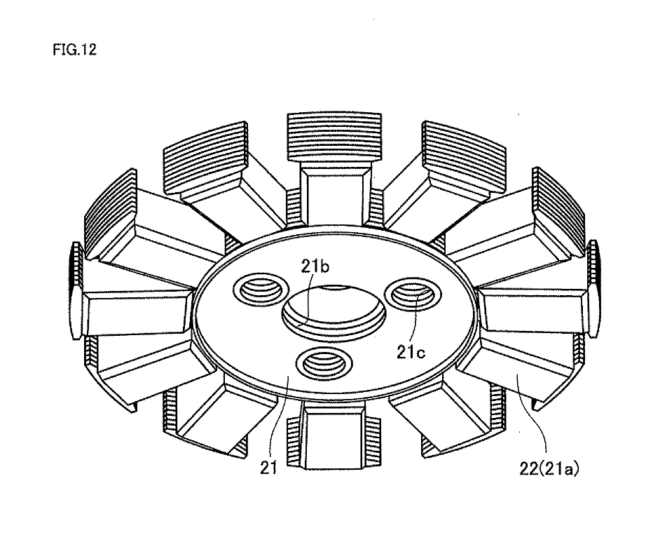

Referring to FIGS. 11 and 12, after stator core 21 is covered with insulator 26, stator coil 22 is wound around each of teeth 21 a of stator core 21. In this manner, a wire-wound assembly is obtained.

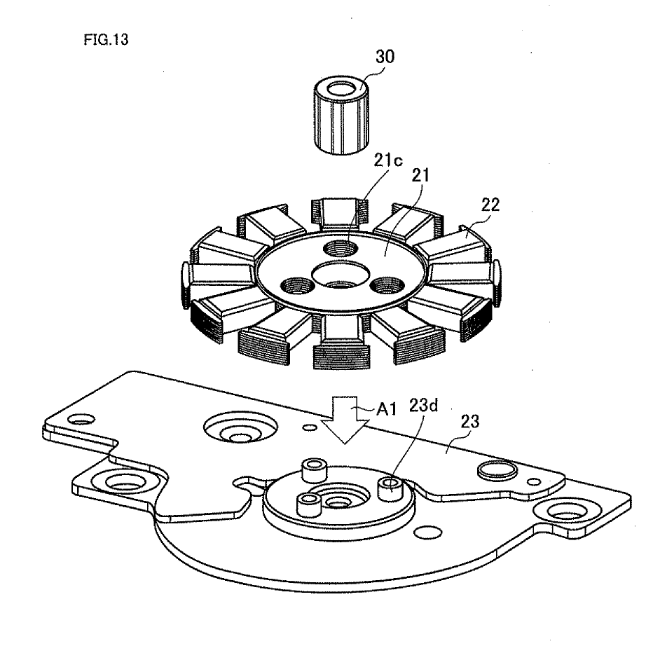

Referring to FIG. 13, burring portions 23d in bracket 23 are fitted into holes 21c formed in stator core 21, respectively, as indicated by an arrow A1, followed by caulking, whereby the wire-wound assembly is mounted in bracket 23.

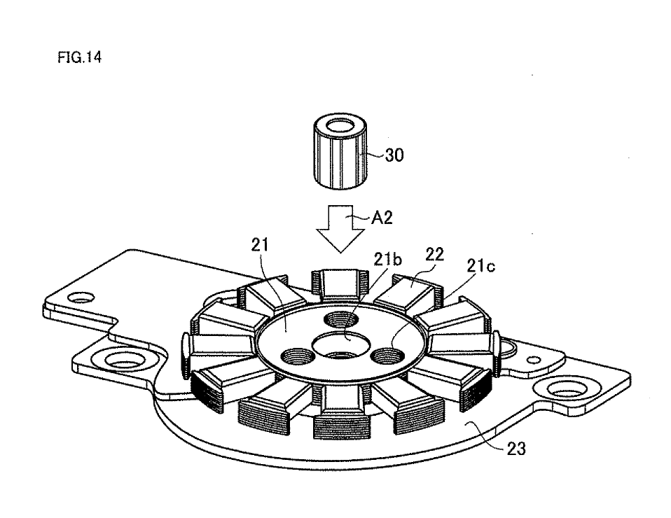

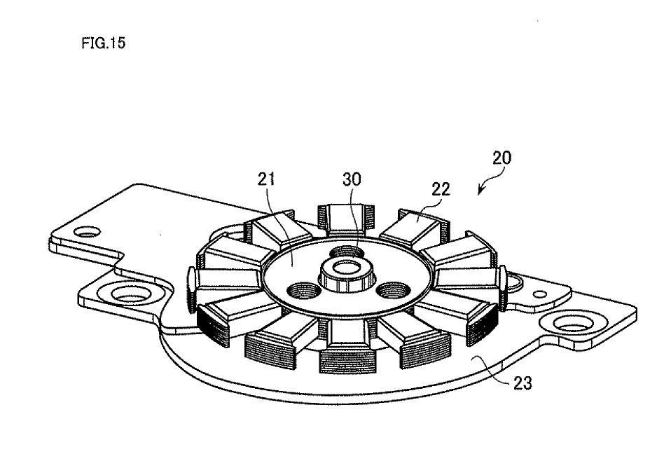

Referring to FIG. 14, bearing 30 is inserted into hole 21b of stator core 21, to be thus press-fitted to stator core 21, as indicated by an arrow A2. Thereafter, the terminal of stator coil 22 is soldered to a board, not shown, on bracket 23. In this manner, stator 20 shown in FIG. 15 is obtained.

Referring to FIG. 4, an attractive magnet, not shown, is disposed at a predetermined position, as required. Next, shaft 13 is inserted into bearing 30, so that rotor 10 is disposed in stator 20. Thereafter, centering member 41 and cushion rubber 42 are mounted on rotor frame 11, thereby completing motor 100.

In the present embodiment, bend 51b obtained by bending a part of plate 51 constituting stator core 21 defines the cylindrical wall surface between bearing 30 and stator core 21. Consequently, the metal oil staying in bearing 30 can be suppressed from being sucked by stator core 21. As a consequence, a bearing housing becomes unnecessary, and therefore, stator core 21 can be tightened directly to bearing 30. Thus, the disk rotating motor can be fabricated in a simple method.

[Modifications of First Embodiment]

Subsequently, a description will be given of modifications of the first embodiment according to the present invention.

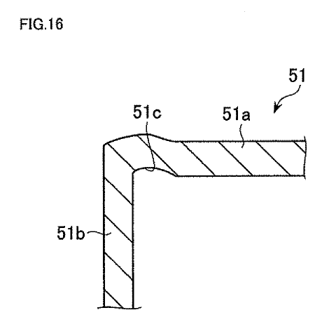

FIG. 16 is a cross-sectional view schematically showing the partial configuration of a plate 51 in the disk rotating motor in a first modification of the first embodiment according to the present invention.

Referring to FIG. 16, plate 51 includes a laminate 51a and a cylindrical bend 51b. Laminate 51a has a flank groove 51c formed on the boundary (an inward round portion) between laminate 51a on a side in contact with a plate 52 (a lower side in FIG. 16) and bend 51b.

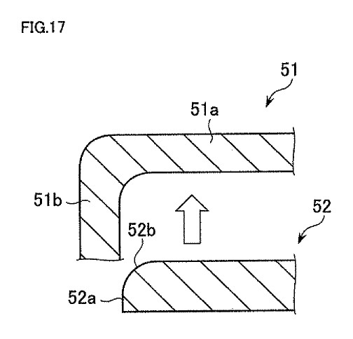

FIG. 17 is a cross-sectional view schematically showing the partial configuration of a plate 51 in the disk rotating motor in a second modification of the first embodiment according to the present invention.

Referring to FIG. 17, a plate 52 that is brought into contact with plate 51 (i.e., a bent laminated core) includes a curved chamfered portion 52b (i.e., a rounded chamfered portion) formed at a portion (i.e., an inner-diameter portion) in contact with the boundary between a laminate 51a and a bend 51b in plate 51. In this manner, plate 52 hardly interferes with the boundary between laminate 51a and bend 51b, thereby enhancing intimate contact between plates 51 and 52.

In the modifications shown in FIGS. 16 and 17, plate 52 hardly interferes with the boundary between laminate 51a and bend 51b, thereby enhancing intimate contact between plates 51 and 52.

In the above-described embodiment, at least one out of the plates constituting the stator core may be bent, although the plurality of plates may be bent. The bent plate may be laminated at any positions, but it should be desirably laminated at the end of the stator core.

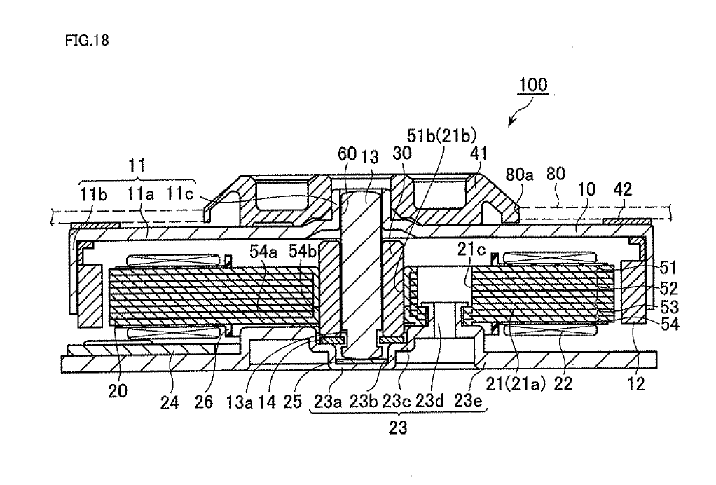

FIG. 18 is a cross-sectional view schematically showing the configuration of the disk rotating motor in a third modification of the first embodiment according to the present invention.

Referring to FIG. 18, in a motor 100 in the present modification, a stator core 21 is constituted of four plates 51 to 54 having different shapes. Plate 54 is a lowermost one out of the plates constituting stator core 21. Plate 54 includes a laminate 54a and a cylindrical bend 54b. Laminate 54a is flat, and is laminated at the lower end of stator core 21 in FIG. 18. Laminate 54a includes a plurality of teeth 21a and holes 21e. Bend 54b is bent upward from laminate 54a on the inner-diameter side of laminate 54a in an axial direction in FIG. 18. Bend 54b mates with a bend 51b of plate 51, and therefore, constitutes a hole 21b in cooperation with bend 51b. Bend 54b and a bearing 30 are tightened to each other by press-fitting, and the inner circumferential surface of bend 54b is brought into contact with the outer peripheral surface of bearing 30. Hole 21c formed in plate 54 has a diameter d2.

[Second Embodiment]

The configuration of a disk drive device in the present embodiment is identical to that of the disk drive device in the first embodiment shown in FIG. 1. Therefore, the description will not be repeated.

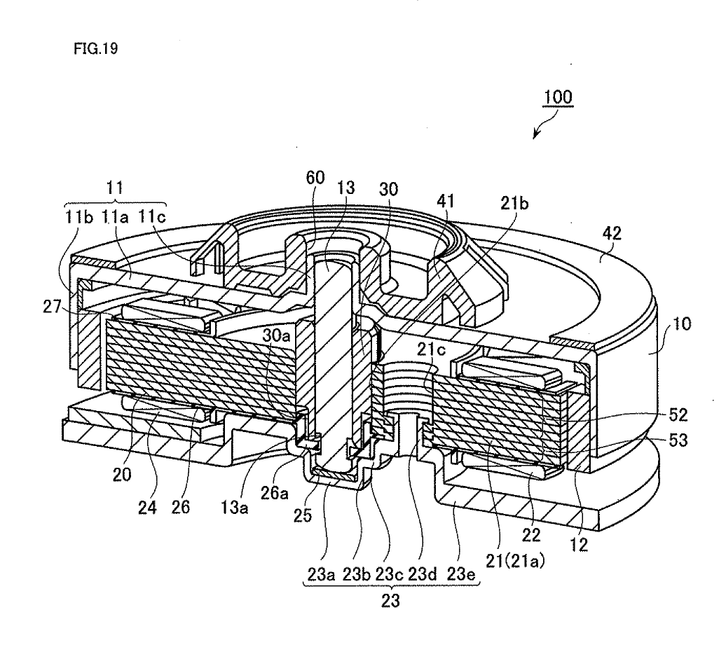

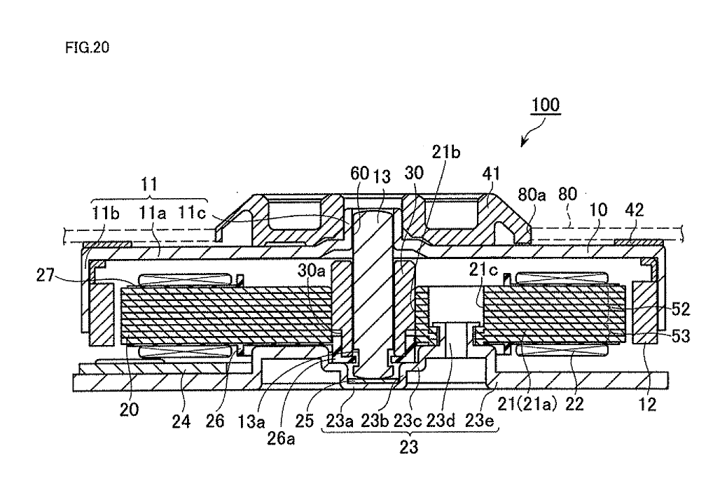

FIGS. 19 and 20 are schematic views showing the configuration of a disk rotating motor in a second embodiment according to the present invention, wherein FIG. 19 is a cross-sectional perspective view taken along the line IV-IV in FIG. 2, and FIG. 20 is a cross-sectional view taken along the line IV-IV in FIG. 2. A bottom view showing a motor 100 serving as the disk rotating motor in the present embodiment is identical to that shown in FIG. 2.

Referring to FIGS. 19 and 20, motor 100 mainly includes a rotor 10, a stator 20, and a bearing 30. Rotor 10 is rotatable with respect to stator 20. Bearing 30 rotatably supports rotor 10 with respect to stator 20.

Rotor 10 includes a rotor frame 11, a magnet 12, and a shaft 13 serving as a rotary shaft. Rotor frame 11 is adapted to prevent leakage of a magnetic field from the inside thereof, and therefore, is made of, for example, a magnetic material. Moreover, rotor frame 11 includes a turn table 11a and a side wall 11b. Turn table 11a extends in, for example, a direction (or a lateral direction in FIG. 20) perpendicular to the extension direction (hereinafter often referred to as an axial direction) of shaft 13. Moreover, turn table 11a is formed into a circular shape, as viewed on a plane. Additionally, turn table 11a has a hole 60, through which shaft 13 is inserted, at the center thereof. As a consequence, rotor frame 11 is fixed to shaft 13 inserted into hole 60. Side wall 11b extends toward a bracket 23 (downward in FIG. 20) in stator 20 from the outer-diameter end of turn table 11a. Moreover, side wall 11b is formed into a cylindrical shape.

Magnet 12 is fixed to the inner circumferential surface of side wall 11b. Magnet 12 is formed into an annular shape, and includes regions magnetized to an N pole and regions magnetized to an S pole alternately at constant intervals in a circumferential direction. Magnet 12 is fixed to rotor frame 11 in such a manner as to face stator 20.

Shaft 13 extends in a vertical direction in FIG. 20 in such a manner as to penetrate the center of rotor frame 11. Rotor frame 11 can be rotated on and with shaft 13. Shaft 13 is rotatably supported by bearing 30 disposed on the outer-diameter side thereof. Shaft 13 has a groove 13a formed at the outer peripheral surface near the lower end in FIG. 20. Groove 13a is formed at a position between bearing 30 and bracket 23.

Stator 20 includes a stator core 21 (i.e., a core), a stator coil 22, bracket 23, a bottom plate 24, a thrust plate 25, and insulators 26 and 27. Stator core 21 is fixed to the outer peripheral surface of bearing 30, and fixed to bracket 23 by, for example, flanging and caulking. Stator core 21 includes a plurality of teeth 21a radially extending from its inner diameter side toward its outer diameter side. Stator coil 22 is wound around each of teeth 21a. Bottom plate 24 is made of, for example, a magnetic material, and is fixed onto rotor 10 side in bracket 23. Thrust plate 25 is formed into, for example, a circular shape, and has a contact surface in contact with the lower end of shaft 13 in FIG. 20. Thrust plate 25 receives a thrust load of shaft 13.

Stator core 21 has a hole 21b (i.e., a core center hole) formed at the center thereof and holes 21e (i.e., peripheral through holes) evenly spaced at a plurality of positions (e.g., three positions) on the circumference of hole 21b. Each of holes 21b and 21c penetrates stator core 21 in the axial direction. Bearing 30 is press-fitted into hole 21b, and therefore, is fixed to stator core 21.

Stator core 21 has a structure in which a plurality of plates are laminated in the axial direction. Stator core 21 is configured by two types of plates 52 and 53 (i.e., laminated cores) having different shapes. Plates 52 and 53 are brought into contact with each other. Plates 52 and 53 are axially laminated in this order from the side of rotor frame 11 (an upper side in FIG. 20) toward the side of bracket 23 (a lower side in FIG. 20). The number of plates 52 and 53 may be optionally determined.

Insulators 26 and 27 are adapted to insulate stator core 21 and stator coil 22 from each other. Insulators 26 and 27 are formed to cover the entire surface of stator core 21. Insulator 26 covers the lower portion of stator core 21 in FIG. 20. In contrast, insulator 27 covers the upper portion of stator core 21 in FIG. 20. Stator coil 22 is wound around each of teeth 21a (i.e., core projecting electrodes) while holding insulators 26 and 27 therebetween. Insulators 26 and 27 should be desirably made of a flexible material such as a resin material.

Bearing 30 is made of, for example, a porous material containing metal oil. Bearing 30 has a recess 30a recessed toward the inner diameter at the lower end at the outer peripheral surface in FIG. 20.

Motor 100 further includes a centering member 41 and a cushion rubber 42. Turn table 11a has an inner-diameter end 11c bent upward in FIG. 20. Centering member 41 is fixed at the outer peripheral surface of inner-diameter end 11c. A spring, not shown, is interposed between centering member 41 and inner-diameter end 11c, to thus urge centering member 41 in the outer-diameter direction. Cushion rubber 42 is disposed at the upper surface of turn table 11a in FIG. 20. When a disk 80 is mounted on the disk drive device, disk 80 is mounted on cushion rubber 42 in such a manner that an opening 80a formed at the center thereof is fitted to centering member 41. Centering member 41 presses the inner circumferential surface of opening 80a of disk 80 by the effect of the spring, thereby fixing disk 80. Cushion rubber 42 is adapted to suppress the vertical vibration of disk 80 in FIG. 20.

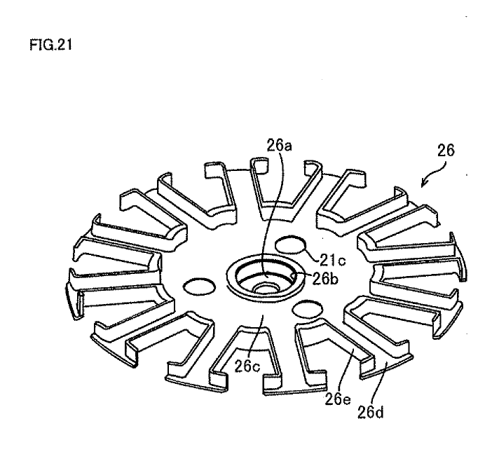

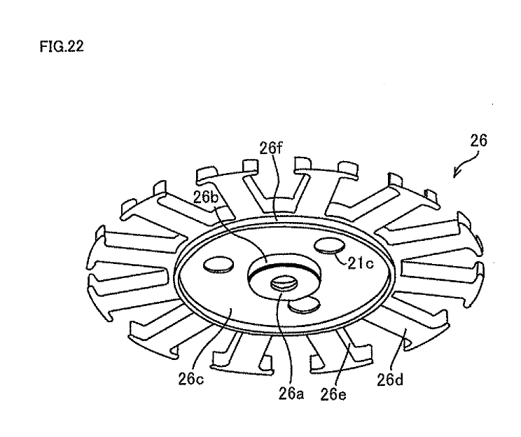

FIGS. 21 and 22 are perspective views showing the configuration of insulator 26 in the second embodiment according to the present invention, wherein FIG. 21 is a view as viewed on a side facing rotor 10 whereas FIG. 22 is a view as viewed on a side facing bracket 23.

Referring to FIGS. 20 to 22, insulator 26 includes a stopper washer 26a (exemplifying a fitted portion), a bearing fitted portion 26b (exemplifying an extending portion), an inner-diameter portion 26c, a plurality of teeth 26d (exemplifying an insulator body), core covering portions 26e, and a partition 26f. Stopper washer 26a, bearing fitted portion 26b, inner-diameter portion 26c, teeth 26d, core covering portions 26e, and partition 26f are formed integrally with each other.

Stopper washer 26a is formed at the end on the inner-diameter side of insulator 26, and projects toward the inner-diameter side. Stopper washer 26a is fitted to groove 13a formed at shaft 13. Stopper washer 26a prevents shaft 13 from falling off upward in FIG. 20.

Bearing fitted portion 26b is formed between the end on the outer-diameter side of stopper washer 26a and the end of the inner-diameter side of inner-diameter portion 26c, and extends from inner-diameter portion 26c downward in the axial direction in FIG. 20. Bearing fitted portion 26b is fitted to recess 30a together with a part of stopper washer 26a.

Inner-diameter portion 26c is formed into a circular shape, and extends from the upper end of bearing fitted portion 26b in the outer-diameter direction in FIG. 20. Inner-diameter portion 26c has holes 21c at positions corresponding to holes 21c formed at plates 52 and 53.

Each of teeth 26d is formed in such a manner as to radially extend from inner-diameter portion 26c toward the outer-diameter side. Each of teeth 26d has a shape corresponding to each of teeth 21a of stator core 21, thereby covering the lower surface of each of teeth 21a in FIG. 20. Each of teeth 26d is formed between stator core 21 and stator coil 22.

Core covering portion 26e extends upward from the circumferential end of each of teeth 26d in FIG. 20, Core covering portion 26e covers the circumferential side surface of each of teeth 26d.

Partition 26f is formed into an annular shape, and projects downward on the boundary between inner-diameter portion 26c and teeth 26d in FIG. 20.

Here, insulator 27 includes members corresponding to teeth 26d, core covering portions 26e, and partition 26f in insulator 26 but does not include members corresponding to stopper washer 26a, bearing fitted portion 26b, and inner-diameter portion 26c in insulator 26.

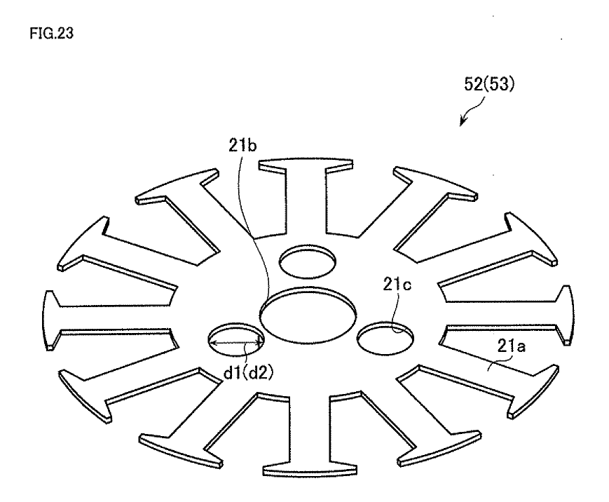

FIG. 23 is a perspective view showing the configuration of plate 52 or 53 in the second embodiment according to the present invention, as viewed on the side facing rotor 10.

Referring to FIGS. 20 and 23, plate 52 (i.e., a core having a large through hole) and plate 53 (i.e., a core having a small through hole) are flat, and are laminated one on another in the axial direction. Plate 52 has teeth 21a, hole 21b, and holes 21c. Similarly, plate 53 has teeth 21a, hole 21b, and holes 21c. Hole 21c of plate 52 has a diameter d1 whereas hole 21c of plate 53 has a diameter d2. Diameter d2 is smaller than diameter d1. Diameter d1 is slightly larger than the diameter of burring portion 23d of bracket 23. Diameter d2 has a size enough that burring portion 23d of bracket 23 and hole 21c of plate 53 are fitted to each other.

A perspective view showing the configuration of bracket 23, as viewed on the side facing rotor 10, is identical to that of FIG. 8.

Incidentally, it is desirable to subject the inner wall surface of stator core 21 in contact with bearing 30 to insulating and grease-proofing. In particular, a capillary action resulting from grease-proofing the inner wall surface of stator core 21 can prevent the metal oil contained in bearing 30 from penetrating inside of plates 52 and 53.

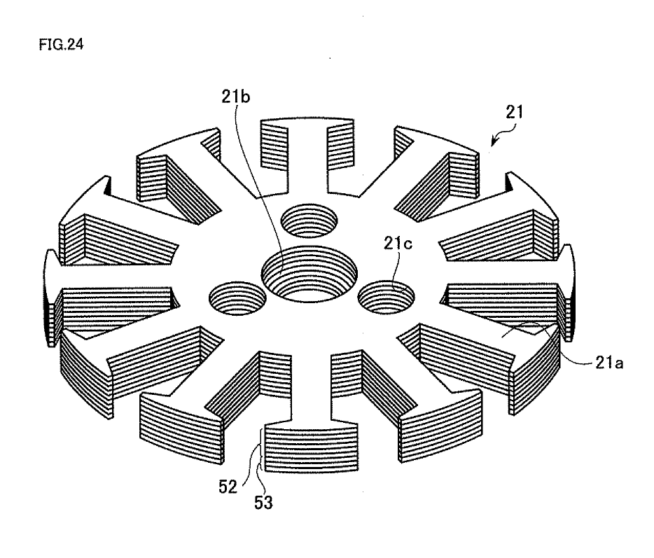

Next, a description will be given of one example of a fabricating method for the disk rotating motor in the present embodiment with reference to FIGS. 24 to 26 and the like.

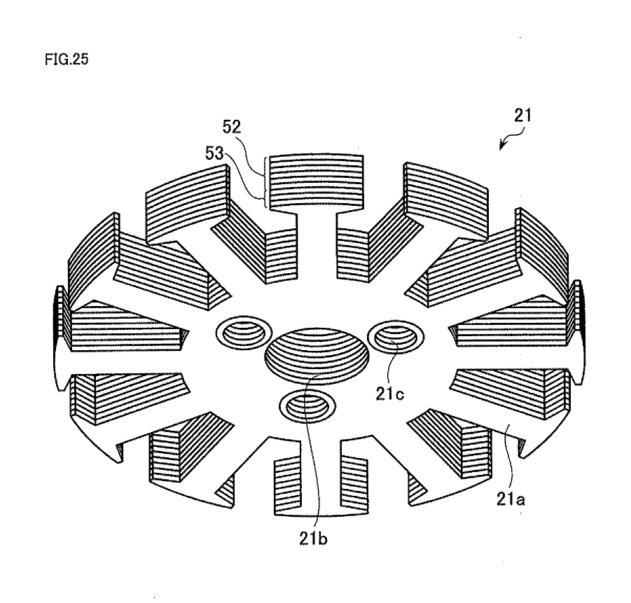

Referring to FIGS. 24 and 25, a piece of metallic flat plate, for example, is first subjected to plastic machining such as pressing, thus fabricating plates 52 and 53. Subsequently, plates 52 and 53 are laminated, thus fabricating stator core 21.

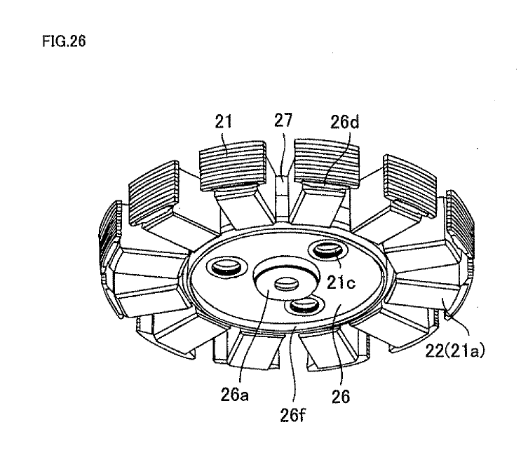

Referring to FIGS. 11 and 26, after stator core 21 is covered with insulators 26 and 27, stator coil 22 is wound around each of teeth 21a of stator core 21. In this manner, a wire-wound assembly is obtained.

Subsequently, referring to FIG. 13, the wire-wound assembly is mounted in bracket 23. Referring to FIG. 14, bearing 30 is press-fitted into stator core 21. Here, bearing 30 is simplified in FIGS. 13 and 14 and recess 30a is not shown.

Thereafter, the terminal of stator coil 22 is soldered to a board, not shown, on bracket 23. In this manner, stator 20 shown in FIG. 15 is obtained.

Referring to FIG. 20, an attractive magnet, not shown, is disposed at a predetermined position, as required. Next, shaft 13 is inserted into bearing 30, so that rotor 10 is disposed in stator 20. At this time, stopper washer 26a of insulator 26 is fitted to groove 13a. In particular, in the case where insulator 26 is made of a flexible material such as a resin material, stopper washer 26a is deformed when shaft 13 is inserted into hole 21b, and then, stopper washer 26a is returned to its original shape when stopper washer 26a is inserted into groove 13a. As a consequence, rotor 10 can be suppressed from falling off from stator 20. Thereafter, centering member 41 and cushion rubber 42 are mounted on rotor frame 11, thereby completing motor 100.

In the present embodiment, the diameter of stopper washer 26a serving as a part of insulator 26 fixed to stator core 21 is set to be greater than the outer diameter of the bottom of groove 13a formed in shaft 13 and smaller than the diameter (i.e., the outer diameter) of the outer peripheral surface of shaft 13. Stopper washer 26a constitutes a mechanism for preventing rotor 10 from falling off, thereby dispensing with a component part for stopping shaft 13, so as to suppress an increase in number of component parts. Moreover, bearing 30 is fixed directly to stator core 21 without any bearing housing, thereby preventing any interference of the inner-diameter side of insulator 26 with a bearing housing, so that stopper washer 26a can be readily fabricated at the end of the inner-diameter side of insulator 26, thus forming insulator 26 into a simple shape. As a consequence, the disk rotating motor can be fabricated in a simple method.

[Modifications of Second Embodiment]

Subsequently, descriptions will be given of modifications of the second embodiment according to the present invention. The configuration other than described below is identical to that in the above-described second embodiment, and therefore, the same members are designated by the same reference numerals and will not be repeatedly described.

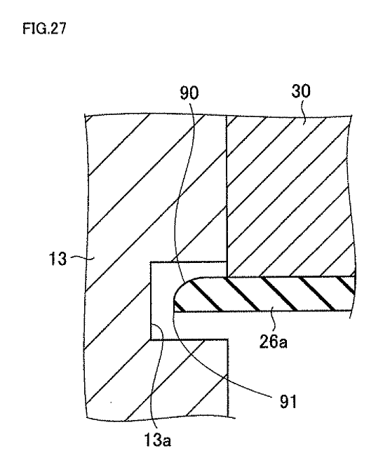

FIG. 27 is a cross-sectional view schematically showing a configuration near a stopper washer 26a in a disk rotating motor in a first modification of the second embodiment according to the present invention. FIG. 27 is the cross-sectional view taken along a plane including a rotary shaft.

Referring to FIG. 27, a stopper washer 26a of an insulator 26 includes a chamfered portion 90 formed on the boundary between a face orienting a bearing 30 side (an upper face in FIG. 27) and an end on an inner-diameter side, and a square portion 91 formed on the boundary between a face orienting a bracket 23 side (a lower face in FIG. 27) and the end on the inner-diameter side. Chamfered portion 90 is chamfered in a curve whereas square portion 91 is not chamfered. The radius of curvature of chamfered portion 90 is greater than that of square portion 91.

In the present modification, the upper face of stopper washer 26a in FIG. 27 is formed into the curved shape: in contrast, the lower face thereof is formed into a flat shape in FIG. 27. Therefore, insulator 26 is readily inserted into a groove 13a, and further, it hardly falls off from groove 13a.

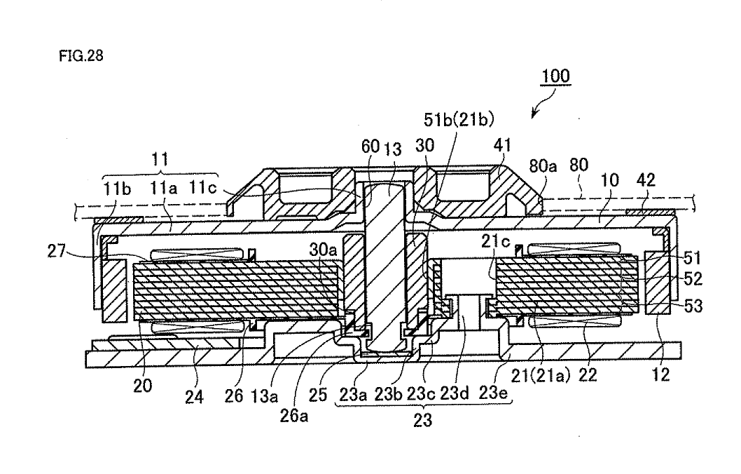

FIG. 28 is a cross-sectional view schematically showing a disk rotating motor in a second modification of the second embodiment according to the present invention.

Referring to FIG. 28, a motor 100 in the present modification is different from the motor in the above-described embodiment in that a stator core 21 further includes a plate 51. Plate 51 is laminated on a plate 52 at the upper end of stator core 21 in FIG. 28.

Here, a perspective view showing the configuration of plate 51, as viewed on a side facing a rotor 10, and a perspective view showing the configuration of plate 51, as viewed on a side facing a bracket 23, are identical to those of FIGS. 5 and 6, respectively.

In the present modification, a bend 51b obtained by bending a part of plate 51 constituting stator core 21 defines a cylindrical wall face between a bearing 30 and stator core 21. As a consequence, it is possible to suppress metal oil staying in bearing 30 from being sucked by stator core 21.

[Effects of Embodiments]

The disk rotating motor that can be fabricated in the simple method, and the disk drive device provided with the same can be provided in the above-described embodiments.

[Others]

The disk rotating motor according to the present invention may be the motor of the shaft rotary type in the above-described embodiments as well as a motor of a shaft stationary type or a motor of a plainly opposite type.

The above-described embodiments may be appropriately combined with each other. For example, plate 54 having the shape shown in FIG. 18 may include the flank groove shown in FIG. 16. Alternatively, plate 53 in contact with plate 54 may include the chamfered portion shown in FIG. 17. The disk rotating motor may include insulator 26 including stopper washer 26a shown in FIG. 27 and stator core 21 including plate 51 shown in FIG. 28.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A disk rotating motor comprising:
a bearing that rotatably supports a rotary shaft on an outer-diameter side of said rotary shaft; and
a stator core that is fixed to an outer peripheral surface of said bearing,
said stator core including first and second plates laminated in an extension direction of said rotary shaft,
said first plate including:
a laminate laminated on said second plate in the extension direction of said rotary shaft; and
a bend bent from said laminate toward said second plate on an inner-diameter side of said laminate, said bend being in contact with the outer peripheral surface of said bearing.

2. The disk rotating motor according to claim 1, wherein said bend extends in the extension direction of said rotary shaft and between an end on the inner-diameter side of said second plate and said bearing.

3. The disk rotating motor according to claim 1, wherein said bend is fixed in contact with both of the end on the inner-diameter side of said second plate and said bearing.

4. The disk rotating motor according to claim 1, wherein said first plate is a plate laminated at the end of said stator core.

5. The disk rotating motor according to claim 1, wherein said second plate is brought into contact with said first plate, and said laminate includes a groove formed on a boundary between said bend at a face on a side in contact with said second plate and the laminate.

6. The disk rotating motor according to claim 1, wherein said second plate is brought into contact with said first plate, and said second plate includes a curved chamfered portion formed at a portion in contact with the boundary between said laminate and said bend.

7. A disk drive device comprising:
the disk rotating motor according to claim 1; and
a controller that controls the drive state of said disk rotating motor.

8. A disk rotating motor comprising:
a rotary shaft;
a bearing that rotatably supports said rotary shaft on an outer-diameter side of said rotary shaft; and
a stator that fixes said bearing,
said stator including:
a stator core that is fixed to an outer peripheral surface of said bearing;
a coil that is wound around said stator core; and
an insulator that insulates said stator core and said coil from each other,
said rotary shaft including a groove formed at an outer peripheral surface of said rotary shaft, said insulator including a fitted portion that is fitted to said groove, wherein said fitted portion is formed at an end on an inner-diameter side of said insulator.

9. The disk rotating motor according to claim 8, wherein said fitted portion includes a curved chamfered portion that is formed on a boundary between one surface of said fitted portion and an end on an inner-diameter side of said fitted portion and a square portion that is formed on a boundary between the other surface of said fitted portion and the end on the inner-diameter side of said fitted portion, a radius of curvature of said chamfered portion being greater than that of said square portion.

10. The disk rotating motor according to claim 8, further comprising:
a bracket that supports one end of said rotary shaft,
wherein said groove is formed at a position between said bearing and said bracket.

11. The disk rotating motor according to claim 8, wherein
said insulator further includes an insulator body that is formed between said stator core and said coil and an extension that extends in an extension direction of said rotary shaft between said insulator body and said fitted portion,
said bearing including a recess that is recessed toward the inner diameter side at the end of the outer peripheral surface of said bearing and is fitted to said extension.

12. The disk rotating motor according to claim 8, wherein said stator core includes first and second plates laminated in the extension direction of said rotary shaft,
said first plate including:
a laminate laminated on said second plate in the extension direction of said rotary shaft; and
a bend bent from said laminate toward said second plate on the inner-diameter side of said laminate, said bend being in contact with the outer peripheral surface of said bearing.

13. A disk drive device comprising:
said disk rotating motor according to claim 8; and
a controller that controls a drive state of said disk rotating motor.
